(19) United States
(12) Patent Application Publication
(10) Pub. No.: US 2018/0012033 A1
(43) Pub. Date: Jan. 11, 2018

(54) METHOD AND APPARATUS OF NON-VOLATILE MEMORY SYSTEM HAVING CAPABILITY OF KEY-VALUE STORE DATABASE

(71) Applicant: HITACHI, LTD., Tokyo (JP)

(72) Inventor: Akio NAKAJIMA, Santa Clara, CA (US)

(21) Appl. No.: 15/538,237

(22) PCT Filed: Mar. 4, 2015
(86) PCT No.: PCT/US2015/018638

§ 371 Date: Jun. 21, 2017

(51) Int. Cl. G06F 21/62; G06F 17/30

(52) U.S. Cl. CPC G06F 21/6218; G06F 17/30321; G06F 17/30424

(57) ABSTRACT

A computer system is coupled to one or more servers which run one or more applications. The computer system comprises: a memory storing key data, value data associated with each of the key data, and application mask data, the application mask data indicating, for each of the value data, which application is allowed to access said each value data based on the key data associated with the value data; and a processor configured to: receive a get operation which includes a first key data and a first application identifier, the first application identifier identifying a first application which issues the get operation; determine whether the first application is allowed to access a first value data associated with the first key data based on the application mask data; and return the first value data if the application mask data indicates the first application is allowed to access the first value data.

### BACKGROUND OF THE INVENTION

The present invention relates generally to storage systems and, more particularly, to non-volatile memory system and key-value store database.

A key-value store (KVS) is a simple database containing a pair of key data and value data. A variety of KVS databases exist, such as MapReduce, Apache CouchDB or MongoDB. A host system stores key data and value data to the KVS using a Put operation. The host system reads value data from the KVS using a Get operation with a key data parameter. The host system deletes the pair of key data and value data using a Delete operation with the key data parameter. When the KVS receives a Get or Delete operation, the KVS searches the same key data entry and returns the pair of key data and value data or deletes the pair of key data and value data.

A memory system including a KVS is known. The memory system has a KVS interface such as a Put, Get and Delete operation using a mapping table of key data address and physical memory address stored value data. The mapping table is similar to a flash memory mapping table containing a pair of logical memory address and physical memory address to manage ware leveling. US 2013/0042055 discloses an example of a memory system including a key-value store.

Currently, a user can develop a service using multiple types of KVS databases. A current memory system containing a KVS interface can be used for only one type of KVS database. When the KVS data is shared by multiple types of KVS databases, the user needs to copy the key-value data for each of the multiple types of KVS databases.

### BRIEF SUMMARY OF THE INVENTION

Exemplary embodiments of the invention provide a way for a memory system to manage KVS data that is shared by multiple KVS applications. In one example, a computer system has one or more hosts, multiple key value store (KVS) database applications, and a memory system. The memory system has a KVS operation program, a key mapping table, and a value data store area. The KVS operation has a parameter of application identifier number. Each entry of the key mapping table contains an application bitmask which identifies ownership of the KVS application. When an application administrator copies from a first KVS database owned by a first KVS application to a second KVS database, the first KVS application issues a list operation to the memory system and gets a list of key data which belongs to the first KVS database (list of source key data). Then the first KVS application (source) sends the list of key data to the second KVS application (destination), and the second KVS application issues a copy request with a parameter of the list of source key data, source application identifier, and destination application identifier. The memory system executes a copy operation based on the source list, and sets a bit of the application bitmask related to the destination application identifier. In this way, the memory system can manage KVS data that is shared by multiple KVS applications. Each of multiple KVS databases can share an entry of key-value pair and reduce the database capacity. In the copy operation, the memory system does not send value data to the host or the network between the host and the memory system.

An aspect of the present invention is directed to a computer system coupled to one or more servers which run one or more applications. The computer system comprises: a memory storing key data, value data which is associated with each of the key data, and application mask data, the application mask data indicating, for each of the value data, which application is allowed to access said each value data based on the key data associated with the value data; and a processor configured to: receive a get operation which includes a first key data and a first application identifier, the first application identifier identifying a first application which issues the get operation; determine whether the first application is allowed to access a first value data which is associated with the first key data based on the application mask data; and return the first value data associated with the first key data if the application mask data indicates the first application is allowed to access the first value data.

In some embodiments, the processor is configured to: receive a put operation which includes a second key data, a second value data which is associated with the second key data, and a second application identifier identifying a second application which issues the put operation; search the application mask data to determine whether any application is allowed to access any existing value data associated with the second key data; and if no application is allowed to access any existing value data associated with the second key data, create and store in the memory a new entry of the second key data, the associated second value data, and the application mask data indicating that the second application is allowed to access the second value data, allocate a new value data area to store the second value data, and update in the memory a physical address of the value data based on the allocated new value data area.

In specific embodiments, the processor is configured to: receive a put operation which includes a second key data, a second value data which is associated with the second key data, and a second application identifier identifying a second application which issues the put operation; search the application mask data to determine whether any application is allowed to access any existing value data associated with the second key data; and if the second application is allowed to access existing value data associated with the second key data and no other application is allowed to access the existing value data associated with the second key data, overwrite the existing value data in the memory with the second value data which is associated with the second key data.

In some embodiments, the processor is configured to: receive a put operation which includes a second key data, a second value data which is associated with the second key data, and a second application identifier identifying a second application which issues the put operation; search the application mask data to determine whether any application is allowed to access any existing value data associated with the second key data; and if the second application is allowed to access existing value data associated with the second key data and at least one other application is allowed to access the existing value data associated with the second key data, update the application mask data corresponding to the second application identifier and the second key data to remove access to the existing value data by the second application, create and store in the memory a new entry of the second key data, the associated second value data, and the application mask data indicating that the second application is allowed to access the second value data, allocate a value data area to store the second value data, and update in the memory a physical address of the value data based on the allocated new value data area.

In specific embodiments, the processor is configured to: receive a list operation which includes a second application identifier identifying a second application which issues the list operation; test the application mask data to identify all second value data which the second application is allowed to access; and create a list of second key data associated with the identified second value data.

In some embodiments, the processor is configured to: receive a copy operation which includes a source application identifier identifying a source application, a destination application identifier identifying a destination application, and a list of key data for the copy operation; determine whether the source application is allowed to access value data which are associated with the key data in the list of key data based on the application mask data; if the source application is allowed to access all value data which are associated with the key data in the list of key data, update the application mask data to indicate that the destination application is allowed to access all value data which are associated with the key data in the list of key data; and if the source application is not allowed to access at least some value data which are associated with the key data in the list of key data, create a failed list of key data associated with value data which the source application is not allowed to access, and return a failure response with the failed list of key data.

In specific embodiments, the processor is configured to: receive a copy operation which includes a source application identifier identifying a source application and a destination application identifier identifying a destination application; create a list of key data which are associated with all value data which the source application is allowed to access based on the application mask data; and update the application mask data to indicate that the destination application is allowed to access all value data which are associated with the key data in the created list of key data.

In some embodiments, the processor is configured to: receive a delete operation which includes a second application identifier and a list of key data for the delete operation; determine whether the second application is allowed to access value data which are associated with the key data in the list of key data based on the application mask data; if the second application is allowed to access all value data which are associated with the key data in the list of key data, update the application mask data to indicate that the second application is not allowed to access all value data which are associated with the key data in the list of key data; and if the second application is not allowed to access at least some value data which are associated with the key data in the list of key data, return a failure response.

In specific embodiments, the processor is configured, if the second application is allowed to access all value data which are associated with the key data in the list of key data, to: identify, from the list of key data, any key data for which the application mask data indicates no application is allowed to access the value data associated with the identified key data; if there are one or more identified key data for which the application mask data indicates no application is allowed to access the value data associated with the identified key data, delete from the memory the one or more identified key data, the value data associated with the one or more identified key data, and stored area of the value data associated with the one or more identified key data.

In some embodiments, the computer system is coupled to a plurality of servers each running one or more applications, each application of the applications running on the plurality of servers being identified by a unique application identifier.

Another aspect of the invention is directed to a method of operating a computer system coupled to one or more servers which run one or more applications. The computer system includes a memory that stores key data, value data which is associated with each of the key data, and application mask data, the application mask data indicating, for each of the value data, which application is allowed to access said each value data based on the key data associated with the value data. The method comprises: receiving a get operation which includes a first key data and a first application identifier, the first application identifier identifying a first application which issues the get operation; determining whether the first application is allowed to access a first value data which is associated with the first key data based on the application mask data; and returning the first value data associated with the first key data if the application mask data indicates the first application is allowed to access the first value data.

In some embodiments, the method further comprises: receiving a put operation which includes a second key data, a second value data which is associated with the second key data, and a second application identifier identifying a second application which issues the put operation; searching the application mask data to determine whether any application is allowed to access any existing value data associated with the second key data; if no application is allowed to access any existing value data associated with the second key data, creating and storing in the memory a new entry of the second key data, the associated second value data, and the application mask data indicating that the second application is allowed to access the second value data, allocating a new value data area to store the second value data, and updating in the memory a physical address of the value data based on the allocated new value data area; if the second application is allowed to access existing value data associated with the second key data and no other application is allowed to access the existing value data associated with the second key data, overwriting the existing value data in the memory with the second value data which is associated with the second key data; and if the second application is allowed to access existing value data associated with the second key data and at least one other application is allowed to access the existing value data associated with the second key data, updating the application mask data corresponding to the second application identifier and the second key data to remove access to the existing value data by the second application, creating and storing in the memory a new entry of the second key data, the associated second value data, and the application mask data indicating that the second application is allowed to access the second value data, allocating a value data area to store the second value data, and updating in the memory a physical address of the value data based on the allocated new value data area.

In specific embodiments, the method further comprises: receiving a copy operation; if the copy operation includes a source application identifier identifying a source application, a destination application identifier identifying a destination application, and a list of key data for the copy operation, then determining whether the source application is allowed to access value data which are associated with the key data in the list of key data based on the application mask data; if the source application is allowed to access all value data which are associated with the key data in the list of key data, updating the application mask data to indicate that the destination application is allowed to access all value data which are associated with the key data in the list of key data; and if the source application is not allowed to access at least some value data which are associated with the key data in the list of key data, creating a failed list of key data associated with value data which the source application is not allowed to access, and return a failure response with the failed list of key data; and if the a copy operation includes a source application identifier identifying a source application and a destination application identifier identifying a destination application, then creating a list of key data which are associated with all value data which the source application is allowed to access based on the application mask data; and updating the application mask data to indicate that the destination application is allowed to access all value data which are associated with the key data in the created list of key data.

In some embodiments, the method further comprises: receiving a delete operation which includes a second application identifier and a list of key data for the delete operation; determining whether the second application is allowed to access value data which are associated with the key data in the list of key data based on the application mask data; if the second application is allowed to access all value data which are associated with the key data in the list of key data, then updating the application mask data to indicate that the second application is not allowed to access all value data which are associated with the key data in the list of key data; identifying, from the list of key data, any key data for which the application mask data indicates no application is allowed to access the value data associated with the identified key data; and if there are one or more identified key data for which the application mask data indicates no application is allowed to access the value data associated with the identified key data, deleting from the memory the one or more identified key data, the value data associated with the one or more identified key data, and stored area of the value data associated with the one or more identified key data; and if the second application is not allowed to access at least some value data which are associated with the key data in the list of key data, returning a failure response.

Another aspect of this invention is directed to a non-transitory computer-readable storage medium storing a plurality of instructions for controlling a data processor to operate a computer system including a memory that stores key data, value data which is associated with each of the key data, and application mask data, the application mask data indicating, for each of the value data, which application is allowed to access said each value data based on the key data associated with the value data. The plurality of instructions comprise: instructions that cause the data processor to receive a get operation which includes a first key data and a first application identifier, the first application identifier identifying a first application which issues the get operation; instructions that cause the data processor to determine whether the first application is allowed to access a first value data which is associated with the first key data based on the application mask data; and instructions that cause the data processor to return the first value data associated with the first key data if the application mask data indicates the first application is allowed to access the first value data.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a configuration of a computer system in which the method and apparatus of the invention may be applied according to a first embodiment of the present invention.

FIGS. 2a and 2b show an example of a memory system.

FIG. 3 shows an example of a key mapping table.

FIG. 4 shows an example of stored area of value data.

FIG. 5 shows a flow diagram illustrating an example of a Get operation of the KVS operation program.

FIG. 6 shows a flow diagram 600 illustrating an example of a Put operation of the KVS operation program.

FIG. 7 shows a flow diagram 700 illustrating an example of a List operation of the KVS operation program according to the first embodiment.

FIG. 8 shows a flow diagram illustrating an example of a Copy operation of the KVS operation program according to the first embodiment.

FIG. 9 shows a flow diagram illustrating an example of a Delete operation of the KVS operation program.

FIG. 10 illustrates an example of a configuration of a computer system in which the method and apparatus of the invention may be applied according to a second embodiment of the present invention.

FIG. 11 shows an example of a result of list operation table of FIG. 2b.

FIG. 12 shows flow diagrams illustrating an example of a Copy operation of the KVS operation program according to a third embodiment of the present invention.

FIG. 13 shows a diagram illustrating an example of a Get operation and a List operation.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transitory medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for a memory system to manage KVS data that is shared by multiple KVS applications.

### First Embodiment

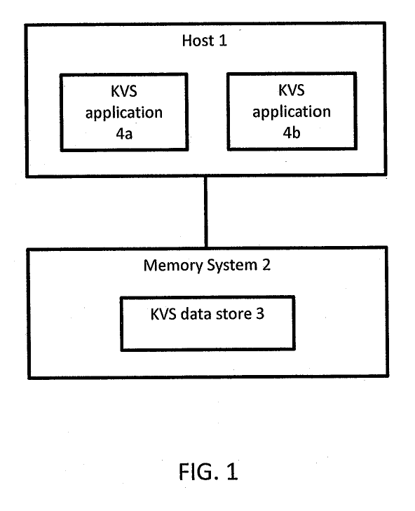

FIG. 1 illustrates an example of a configuration of a computer system in which the method and apparatus of the invention may be applied according to a first embodiment of the present invention. The computer system includes a host 1 and a memory system 2. The host 1 contains plural host I/F (interfaces) which connect to the host, CPU, memory, Disk I/F, and HDDs, and connect each component by a bus I/F such as PCI, DDR, and SCSI. The memory of the host 1 has multiple key-value store (KVS) application software 4. Each KVS application has a unique application number. The application number is used to identify the owner of the key value pair. The memory system 2 has KVS data store 3. The memory system 2 has capability of KVS operation such as Get, Put, List, and Delete operations. When the KVS application 4 issues a KVS operation to the memory system 2, the memory system 2 executes the KVS operation and stores or loads the pair of key data and value data in the KVS data store 3.

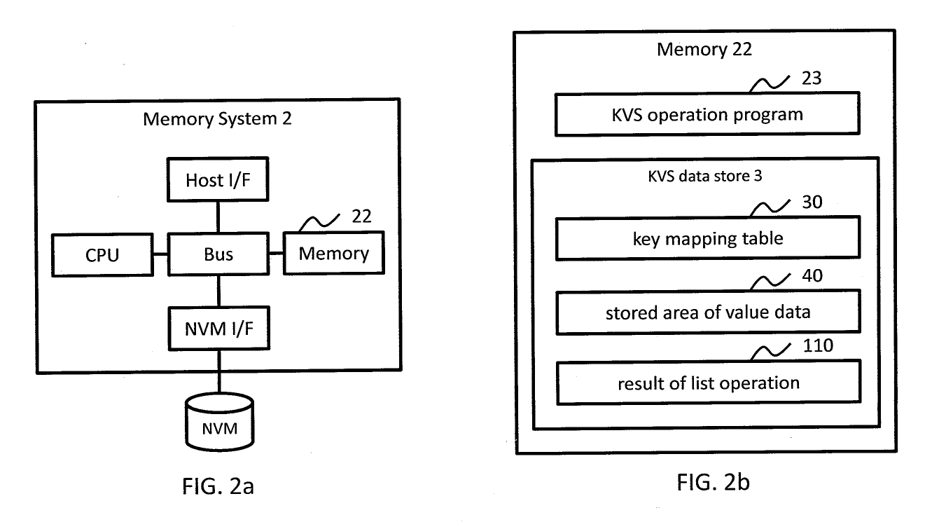

FIGS. 2a and 2b show an example of a memory system. The memory system 2 contains plural of host I/F which connect to the host, CPU, memory 22, Disk I/F, and HDDs, and connect each component by bus I/F such as PCI, DDR, and SCSI. The memory 22 of the memory system 2 includes a KVS operation program 23 and a KVS data store 3. The KVS data store 3 includes a key mapping table 30, a stored area of value data 40, and a result of list operation 110.

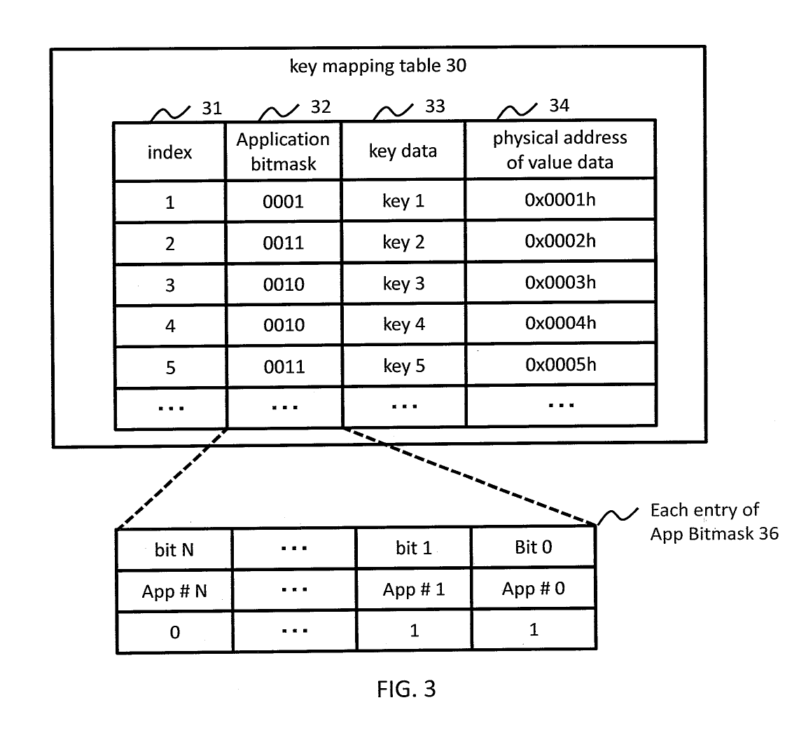

FIG. 3 shows an example of a key mapping table. The key mapping table 30 contains index field 31, application bitmask field 32, key data field 33, and physical address of value data 34. The index field 31 is a unique value of the table entry. The pair of application bitmask 32 and key data 33 present a unique value. The application bitmask field 32 is identification of multiple KVS applications 4. Each entry of application bitmask 36 illustrates the multiple KVS applications (App #0, App #1, . . . to App #N corresponding to Bit 0, Bit 1, . . . to Bit N, respectively). The application bitmasks comprise application mask data which indicate which application is allowed to access which value data based on the key data associated with the value data. The key data field 33 contains key data of the pair of the key data and value data. The physical address of value data field 34 contains physical address of stored area of the value data 40. The physical address of value data 34 points to the value data.

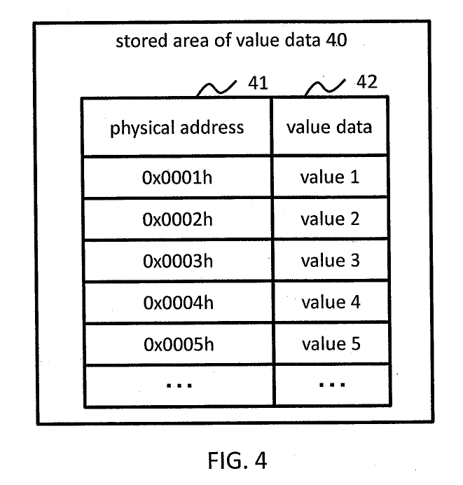

FIG. 4 shows an example of stored area of value data. The stored area of value data 40 contains physical address field 41 and value data field 42. The physical address field 41 is a stored address of a value data. The value data field 42 contains the value data of a pair of the key data and the value data.

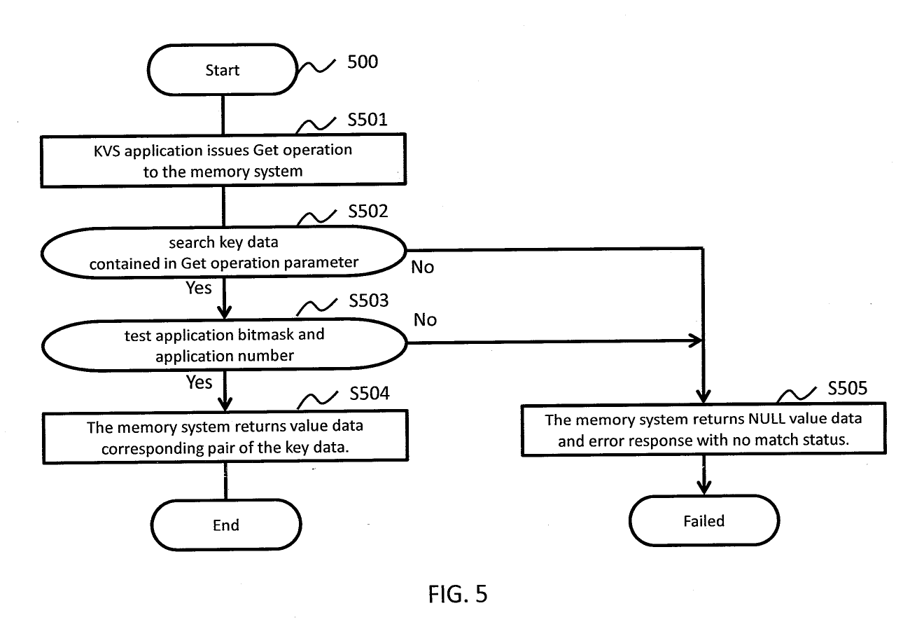

FIG. 5 shows a flow diagram 500 illustrating an example of a Get operation of the KVS operation program. In step S501, the KVS application 4 issues a Get operation to the memory system 2. The Get operation includes parameters of key data and application number. The KVS program 23 receives the Get operation. In step S502, the KVS program 23 searches the key mapping table 30 for the key data contained in the Get operation parameters. If the key data is a match for at least one entry in the key data field 33 of the key mapping table 30, the next step is S503. If there is no match, the next step is S505. In step S503, the KVS program 23 tests the application number contained in the Get operation parameters and the application bitmask for each matched entry which is searched in step S502. If the bit corresponding to the application number in the application bitmask is set to 1, indicating that the entry of key data is owned by the KVS application, the next step is S504. If no application bitmask which is searched in step S502 is a match to the application number of the Get operation, indicating that all of the key data entries are not owned by the KVS application, the next step is S505.

In step S504, the KVS program 23 reads the value data corresponding to the key data in a pair of the key data and value data using the physical address of the value data field 34, and then the memory system 2 returns the value data with a success response. In contrast, in step S505, since the KVS data store does not store the key data corresponding to the Get operation request issued by the KVS application, the memory system 2 returns NULL value data and error response with no match status.

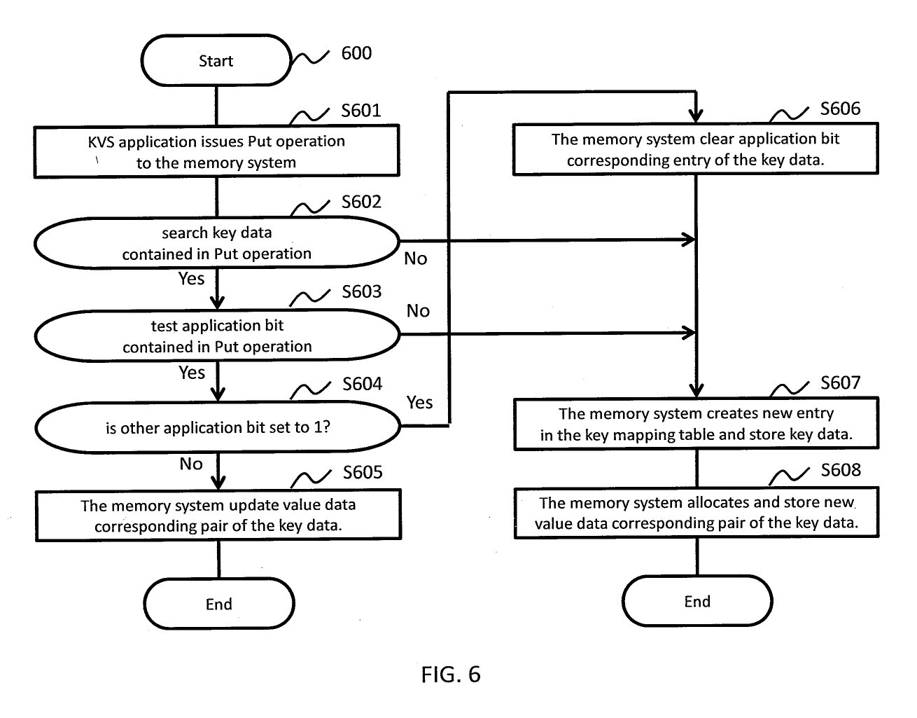

FIG. 6 shows a flow diagram 600 illustrating an example of a Put operation of the KVS operation program. In step S601, the KVS application 4 issues a Put operation to the memory system 2. The Put operation contains parameters of key data, value data, and application number. The KVS program 23 receives the Put operation. In step S602, the KVS program 23 searches the key data contained in the Put operation parameters. If the key data is a match for at least one entry in the key data field 33 of the key mapping table 30, the next step is S603. If there is no match, the next step is S607.

In step S603, the KVS program 23 tests the application number contained in the Put operation parameters and multiple entry of application bitmask for each matched entry which is searched in step S602. If the bit corresponding to the application number in the application bitmask is set to 1, so that the entry of key data is owned by the KVS application, then the next step is S604. If no application bitmask which is searched in step S602 is matched to the application number of the Put operation, so that all of the key data entries are not owned by the KVS application, then the next step is S607.

In step S604, the KVS program 23 tests any other application number except the application number contained in the Put operation parameters and the application bitmask which is tested in step S603. If any bit is set to 1, so that the entry of key data is shared by the other KVS application, then the next step is S606. If all bits excluding the application number of the Put operation are set to 0, so that the key data entry is not shared by the other KVS application, then the next step is S605.

In step S605, the KVS program 23 overwrites the value data contained in the Put parameters to the location of value data using the physical address of the value data field 34, and then the memory system 2 returns a success response. In step S606, the KVS program 23 clears the bit of the application number contained in the Put operation parameters in the application bitmask which is tested in step S604. The entry which is tested in step S604 is unregistered owner of the KVS application. Clearing the bit of the application number contained in the Put operation parameters in the application bitmask means setting the bit corresponding to the application number to zero for the application bitmask tested in step S604. This updates the application bitmask corresponding to the application number and the key data, to remove access to the existing value data associated with the key data by the application identified by the application number. Then the next step is S607.

In step S607, the KVS program 23 creates a new entry of the key data in the key mapping table 30, and then the KVS program 23 stores the key data and the bit corresponding to the application number in the application bitmask is set to 1. The entry is owned by the KVS application. In step S608, the KVS program 23 allocates a new value data area and stores the value data contained in the Put parameters to the allocated location of value data. The KVS program 23 updates the physical address of the value data field 34, and then the memory system 2 returns a success response.

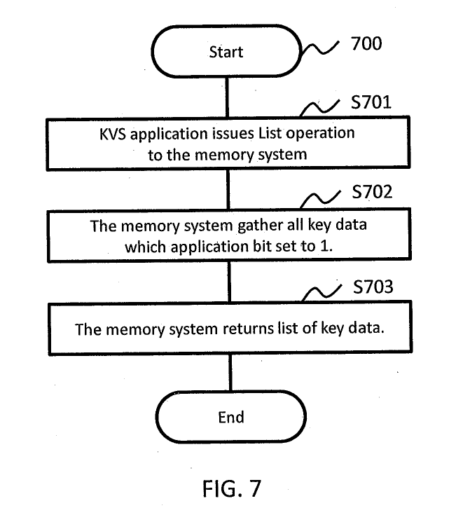

FIG. 7 shows a flow diagram 700 illustrating an example of a List operation of the KVS operation program according to the first embodiment. In step S701, the KVS application 4 issues a List operation to the memory system 2. The List operation contains a parameter of application number. The KVS program 23 receives the List operation. Also, the List operation contains an optional parameter of conditional operation to select value data based on the conditional operation (for example, if the value data is higher than a numerical value 100, select the key data). In step S702, the KVS program 23 tests the application number contained in the List operation parameter and application bitmask for all entries in the key mapping table 30. Then the KVS program 23 gathers all key data for which the bit corresponding to the application number is set to 1. If the List operation contains the optional parameter, then the KVS program executes the conditional operation as well. In step S703, the KVS program 23 creates a list of all key data with corresponding application number set to 1 and hence owned by the KVS application, and then the memory system 2 returns the list of all key data with a success response.

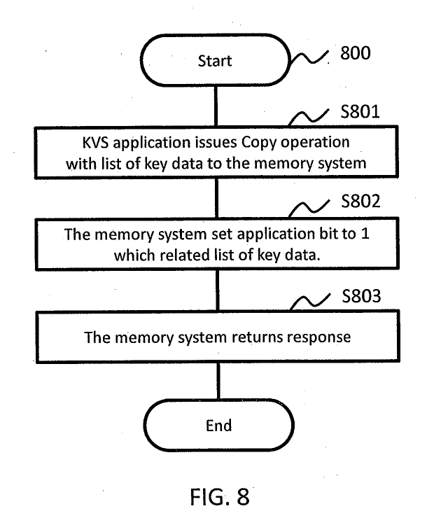

FIG. 8 shows a flow diagram 800 illustrating an example of a Copy operation of the KVS operation program according to the first embodiment. In step S801, the KVS application 4 issues a Copy operation to the memory system 2. The Copy operation contains parameters of the source application number, the destination application number, and list of multiple key data (note that the list of multiple key data may be treated as an optional parameter if the default is to copy the entire list). The KVS program 23 receives the operation. In step S802, the KVS program 23 searches all list of key data with the source application number. Each key data search operation is similar to steps S502 and S503 in FIG. 5. Then the KVS program 23 sets a bit corresponding to the destination application number contained in the copy operation parameters to each application bitmask for all entries which are searched. If there is any key data with source application number which is not a match, the entry is a failed copy operation and the KVS program 23 creates a list of key data which failed the copy operation and adds the entry to that list. In step S803, the KVS program 23 returns a success response when all entries are copied. If any entry is a failed copy operation in step S802, the KVS program 23 returns the failed list of key data with a failure response.

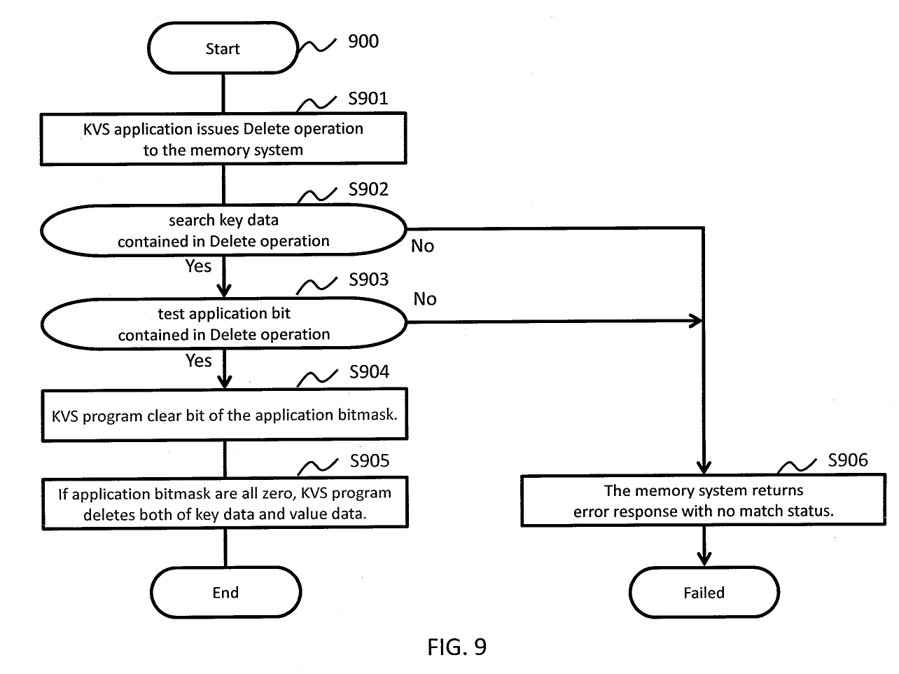

FIG. 9 shows a flow diagram 900 illustrating an example of a Delete operation of the KVS operation program. Steps S901 to S903 are similar to steps S501 to S503 in the FIG. 5. In step S904, the KVS program 23 clears the bit of the application bitmask for each matched entry of the Delete operation. When the application bitmasks are all zero for the matched entries, in step S905, the KVS program deletes the corresponding entries including both the key data and the value data from the key mapping table 30 and the stored area of value data 40 using the physical address of the value data field 34. The application bitmasks are all zero for a key data if no application is allowed access to the value data associated with the key data. Then the memory system 2 returns a success response. In step S906, the KVS data store does not store the key data corresponding to the key data in the request issued from the KVS application, and the memory system 2 returns an error response with no match status.

### Second Embodiment

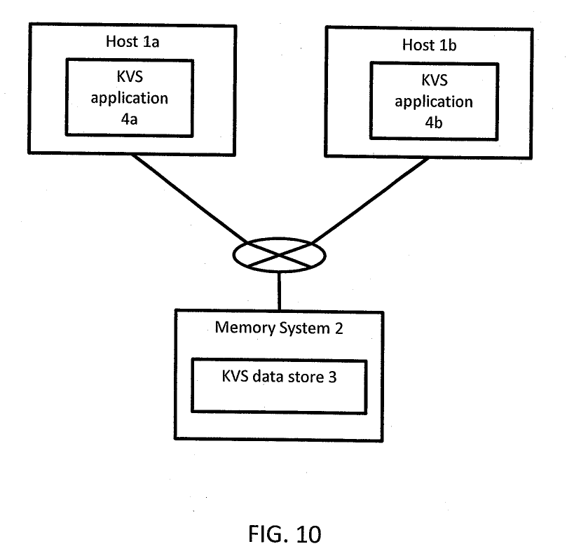

FIG. 10 illustrates an example of a configuration of a computer system in which the method and apparatus of the invention may be applied according to a second embodiment of the present invention. The computer system includes multiple hosts 1 (1a, 1b) and a memory system 2. The memory system 2 is connected to each host 1 via a network. The memory of each host 1 has at least one key-value store (KVS) application software 4. Each KVS application 4 has a unique application number.

### Third Embodiment

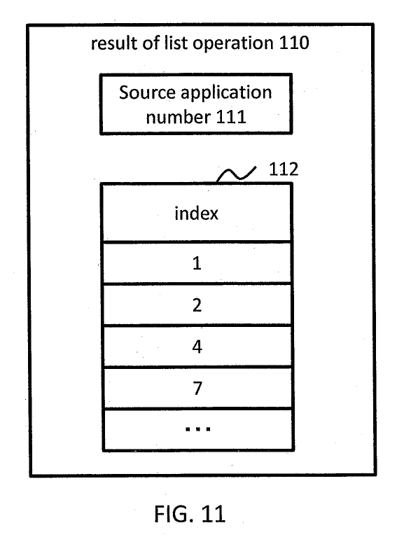

FIG. 11 shows an example of a result of list operation table of FIG. 2b. The result of list operation table 110 contains a source application number 111 and a list result table 112. The source application number 111 contains an application number of the List operation. The list result table 112 has an index field. The indexes are results of the List operation.

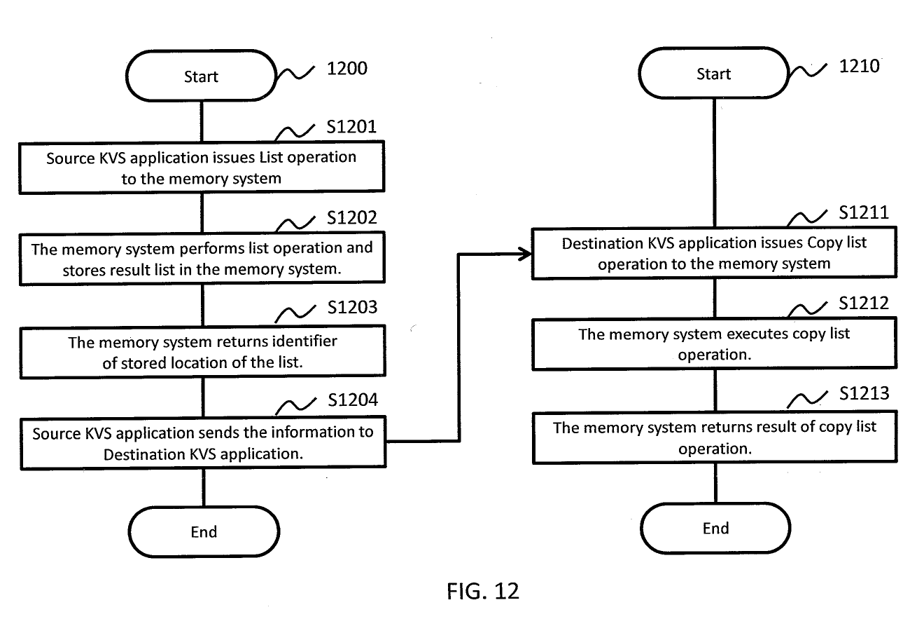

FIG. 12 shows flow diagrams 1200 and 1210 illustrating an example of a Copy operation of the KVS operation program according to a third embodiment of the present invention. The flow diagram 1200 is related to the List operation of the source KVS application. In step S1201, the source KVS application 4 issues a List operation to the memory system 2. In step S1202, the KVS program 23 executes the List operation. The execution of the List operation is similar to that of FIG. 7. Then the KVS program 23 stores the result of list operation 110 in the memory system. In step S1203, the KVS program 23 returns the identifier of the stored location of the result of list operation 110 to the source KVS application. In step S1204, the source KVS application 4 sends the identifier information of the result of list operation 110 to the destination KVS application.

The flow diagram 1210 is related to a Copy operation of the destination KVS application. In step S1211, the destination KVS application 4 issues a Copy List operation to the memory system 2 with a parameter of the identifier information which is received in step S1204. In step S1212, the KVS program 23 executes the Copy List operation using the result of list operation 110 stored in the memory system. The execution of the Copy List operation is similar to the execution of the Copy operation of FIG. 8. In step S1213, the KVS program 23 returns the result of the Copy List operation to the destination KVS application.

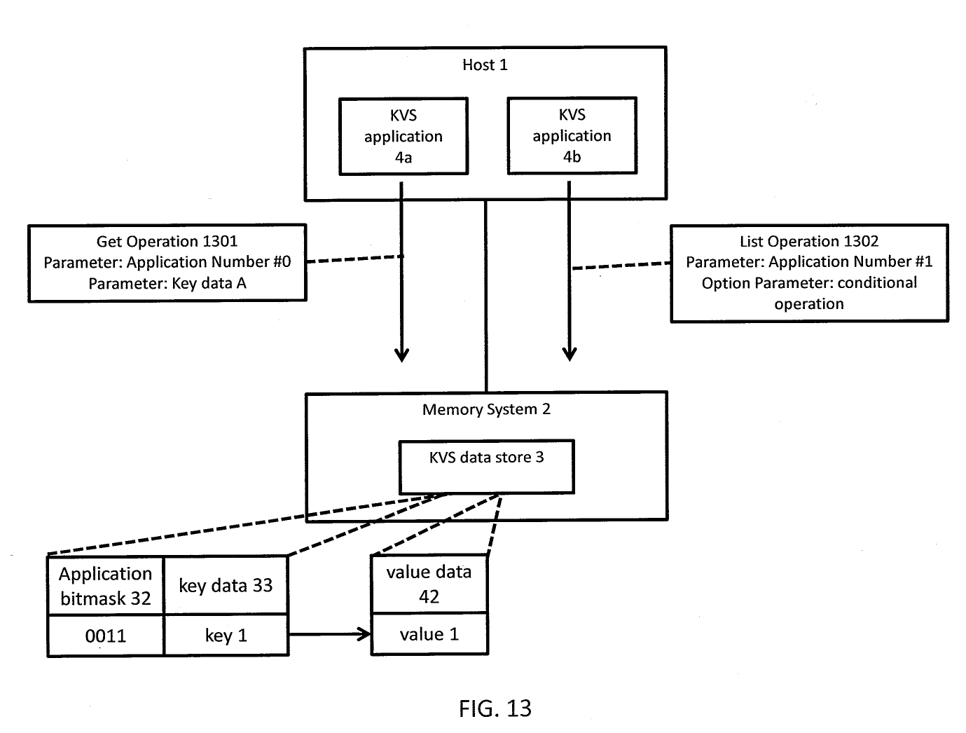

FIG. 13 shows a diagram illustrating an example of a Get operation and a List operation. The KVS application 4a issues a Get operation 1301 to the memory system 2 with parameters of application number #0 and key data A. The KVS application 4b issues a List operation 1302 with parameter of application number #1 and optional parameter of conditional operation. In the KVS data store 3 of the memory system 2, an application bit mask 32 of 0011 has an entry of key 1 for the key data 33 with a corresponding entry of value 1 for the value data 42.

Of course, the system configurations illustrated in FIGS. 1 and 10 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for a memory system to manage KVS data that is shared by multiple KVS applications. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A computer system coupled to one or more servers which run one or more applications, the computer system comprising:
a memory storing key data, value data which is associated with each of the key data, and application mask data, the application mask data indicating, for each of the value data, which application is allowed to access said each value data based on the key data associated with the value data; and
a processor configured to:
receive a get operation which includes a first key data and a first application identifier, the first application identifier identifying a first application which issues the get operation;
determine whether the first application is allowed to access a first value data which is associated with the first key data based on the application mask data; and
return the first value data associated with the first key data if the application mask data indicates the first application is allowed to access the first value data.

2. The computer system according to claim 1, wherein the processor is configured to:
receive a put operation which includes a second key data, a second value data which is associated with the second key data, and a second application identifier identifying a second application which issues the put operation;
search the application mask data to determine whether any application is allowed to access any existing value data associated with the second key data; and
if no application is allowed to access any existing value data associated with the second key data, create and store in the memory a new entry of the second key data, the associated second value data, and the application mask data indicating that the second application is allowed to access the second value data, allocate a new value data area to store the second value data, and update in the memory a physical address of the value data based on the allocated new value data area.

3. The computer system according to claim 1, wherein the processor is configured to:
receive a put operation which includes a second key data, a second value data which is associated with the second key data, and a second application identifier identifying a second application which issues the put operation;
search the application mask data to determine whether any application is allowed to access any existing value data associated with the second key data; and
if the second application is allowed to access existing value data associated with the second key data and no other application is allowed to access the existing value data associated with the second key data, overwrite the existing value data in the memory with the second value data which is associated with the second key data.

4. The computer system according to claim 1, wherein the processor is configured to:
receive a put operation which includes a second key data, a second value data which is associated with the second key data, and a second application identifier identifying a second application which issues the put operation;
search the application mask data to determine whether any application is allowed to access any existing value data associated with the second key data; and
if the second application is allowed to access existing value data associated with the second key data and at least one other application is allowed to access the existing value data associated with the second key data, update the application mask data corresponding to the second application identifier and the second key data to remove access to the existing value data by the second application, create and store in the memory a new entry of the second key data, the associated second value data, and the application mask data indicating that the second application is allowed to access the second value data, allocate a value data area to store the second value data, and update in the memory a physical address of the value data based on the allocated new value data area.

5. The computer system according to claim 1, wherein the processor is configured to:
receive a list operation which includes a second application identifier identifying a second application which issues the list operation;
test the application mask data to identify all second value data which the second application is allowed to access; and
create a list of second key data associated with the identified second value data.

6. The computer system according to claim 1, wherein the processor is configured to:
receive a copy operation which includes a source application identifier identifying a source application, a destination application identifier identifying a destination application, and a list of key data for the copy operation;
determine whether the source application is allowed to access value data which are associated with the key data in the list of key data based on the application mask data;
if the source application is allowed to access all value data which are associated with the key data in the list of key data, update the application mask data to indicate that the destination application is allowed to access all value data which are associated with the key data in the list of key data; and
if the source application is not allowed to access at least some value data which are associated with the key data in the list of key data, create a failed list of key data associated with value data which the source application is not allowed to access, and return a failure response with the failed list of key data.

7. The computer system according to claim 1, wherein the processor is configured to:
receive a copy operation which includes a source application identifier identifying a source application and a destination application identifier identifying a destination application;
create a list of key data which are associated with all value data which the source application is allowed to access based on the application mask data; and
update the application mask data to indicate that the destination application is allowed to access all value data which are associated with the key data in the created list of key data.

8. The computer system according to claim 1, wherein the processor is configured to:
receive a delete operation which includes a second application identifier and a list of key data for the delete operation;
determine whether the second application is allowed to access value data which are associated with the key data in the list of key data based on the application mask data;
if the second application is allowed to access all value data which are associated with the key data in the list of key data, update the application mask data to indicate that the second application is not allowed to access all value data which are associated with the key data in the list of key data; and
if the second application is not allowed to access at least some value data which are associated with the key data in the list of key data, return a failure response.

9. The computer system according to claim 8, wherein the processor is configured, if the second application is allowed to access all value data which are associated with the key data in the list of key data, to:
identify, from the list of key data, any key data for which the application mask data indicates no application is allowed to access the value data associated with the identified key data;
if there are one or more identified key data for which the application mask data indicates no application is allowed to access the value data associated with the identified key data, delete from the memory the one or more identified key data, the value data associated with the one or more identified key data, and stored area of the value data associated with the one or more identified key data.

10. The computer system according to claim 1,
wherein the computer system is coupled to a plurality of servers each running one or more applications, each application of the applications running on the plurality of servers being identified by a unique application identifier.

11. A method of operating a computer system coupled to one or more servers which run one or more applications, the computer system including a memory that stores key data, value data which is associated with each of the key data, and application mask data, the application mask data indicating, for each of the value data, which application is allowed to access said each value data based on the key data associated with the value data, the method comprising:
receiving a get operation which includes a first key data and a first application identifier, the first application identifier identifying a first application which issues the get operation;
determining whether the first application is allowed to access a first value data which is associated with the first key data based on the application mask data; and
returning the first value data associated with the first key data if the application mask data indicates the first application is allowed to access the first value data.

12. The method according to claim 11, further comprising:
receiving a put operation which includes a second key data, a second value data which is associated with the second key data, and a second application identifier identifying a second application which issues the put operation;
searching the application mask data to determine whether any application is allowed to access any existing value data associated with the second key data;
if no application is allowed to access any existing value data associated with the second key data, creating and storing in the memory a new entry of the second key data, the associated second value data, and the application mask data indicating that the second application is allowed to access the second value data, allocating a new value data area to store the second value data, and updating in the memory a physical address of the value data based on the allocated new value data area;
if the second application is allowed to access existing value data associated with the second key data and no other application is allowed to access the existing value data associated with the second key data, overwriting the existing value data in the memory with the second value data which is associated with the second key data; and
if the second application is allowed to access existing value data associated with the second key data and at least one other application is allowed to access the existing value data associated with the second key data, updating the application mask data corresponding to the second application identifier and the second key data to remove access to the existing value data by the second application, creating and storing in the memory a new entry of the second key data, the associated second value data, and the application mask data indicating that the second application is allowed to access the second value data, allocating a value data area to store the second value data, and updating in the memory a physical address of the value data based on the allocated new value data area.

13. The method according to claim 11, further comprising:
receiving a copy operation;
if the copy operation includes a source application identifier identifying a source application, a destination application identifier identifying a destination application, and a list of key data for the copy operation, then
determining whether the source application is allowed to access value data which are associated with the key data in the list of key data based on the application mask data;
if the source application is allowed to access all value data which are associated with the key data in the list of key data, updating the application mask data to indicate that the destination application is allowed to access all value data which are associated with the key data in the list of key data; and
if the source application is not allowed to access at least some value data which are associated with the key data in the list of key data, creating a failed list of key data associated with value data which the source application is not allowed to access, and return a failure response with the failed list of key data; and
if the a copy operation includes a source application identifier identifying a source application and a destination application identifier identifying a destination application, then
creating a list of key data which are associated with all value data which the source application is allowed to access based on the application mask data; and
updating the application mask data to indicate that the destination application is allowed to access all value data which are associated with the key data in the created list of key data.

14. The method according to claim 11, further comprising:
receiving a delete operation which includes a second application identifier and a list of key data for the delete operation;
determining whether the second application is allowed to access value data which are associated with the key data in the list of key data based on the application mask data;
if the second application is allowed to access all value data which are associated with the key data in the list of key data, then
updating the application mask data to indicate that the second application is not allowed to access all value data which are associated with the key data in the list of key data;
identifying, from the list of key data, any key data for which the application mask data indicates no application is allowed to access the value data associated with the identified key data; and
if there are one or more identified key data for which the application mask data indicates no application is allowed to access the value data associated with the identified key data, deleting from the memory the one or more identified key data, the value data associated with the one or more identified key data, and stored area of the value data associated with the one or more identified key data; and
if the second application is not allowed to access at least some value data which are associated with the key data in the list of key data, returning a failure response.

15. A non-transitory computer-readable storage medium storing a plurality of instructions for controlling a data processor to operate a computer system including a memory that stores key data, value data which is associated with each of the key data, and application mask data, the application mask data indicating, for each of the value data, which application is allowed to access said each value data based on the key data associated with the value data, the plurality of instructions comprising:
instructions that cause the data processor to receive a get operation which includes a first key data and a first application identifier, the first application identifier identifying a first application which issues the get operation;
instructions that cause the data processor to determine whether the first application is allowed to access a first value data which is associated with the first key data based on the application mask data; and
instructions that cause the data processor to return the first value data associated with the first key data if the application mask data indicates the first application is allowed to access the first value data.
